(19) United States
(12) Patent Application Publication
(10) Pub. No.: US 2014/0042307 A1
(43) Pub. Date: Feb. 13, 2014

(54) OPTICAL CANTILEVERY BASED SAMPLE ANALYSIS

(71) Applicant: Roger Jeffery, City Beach (AU)

(72) Inventor: Roger Jeffery, City Beach (AU)

(73) Assignee: Panorama Synergy Ltd., Sydney, New South Wales (AU)

(21) Appl. No.: 14/000,744

(22) PCT Filed: Feb. 24, 2012
(86) PCT No.: PCT/AU2012/000185

§ 371 Date: Oct. 28, 2013

(30) Foreign Application Priority Data
Feb. 25, 2011 (AU) 2011900669

(51) Int. Cl. G02F 1/01; G01N 21/59

(52) U.S. Cl. CPC G02F 1/011; G01N 21/59
USPC 250/227.14; 385/1

(57) ABSTRACT

An apparatus and method for analysing a sample. The apparatus comprises a waveguide (205), including an input for receiving light and an output, a first microring resonator (210) optically coupled to the waveguide (205), and a first flexible optical waveguide (215) optically coupled to the first microring resonator (210). The first flexible optical waveguide (215) includes a portion for interacting with the sample. Light transmitted from the output of said waveguide (205) is modulated at a first optical resonant wavelength of the first microring resonator (210) and the modulation is a function of a distance between the first flexible optical waveguide (215) and the first microring resonator (210).

### FIELD OF THE INVENTION

The present invention relates to an apparatus and method for analysing a sample, and more particularly to analysis of a sample using optical waveguides.

### BACKGROUND OF THE INVENTION

Different methods of analysing a sample for detecting chemical and biological analytes have been used. Such technology has been used, for example, in process control, environmental monitoring, medical diagnostics and security.

Mass spectroscopy is one approach to detect such analytes. The process begins with an ionized sample. The ionized sample is shot through a vacuum that is subjected to an electromagnetic field. The electromagnetic field changes the path of lighter ions more than heavier ions. A series of detectors or a photographic plate are then used to sort the ions depending on their mass. The output of this process, which is the signal from the detectors or the photographic plate, can be used to determine the composition of the analytes in the sample.

A disadvantage of mass spectroscopy instruments is that they are generally high-cost instruments. Additionally, they are difficult to ruggedize, and are not useful for applications that require a sensor head to be remote from signal-processing electronics.

A more recent approach is to use Micro Electro Mechanical Systems (MEMS)-based microstructures, and more specifically micro-cantilevers. These are extremely sensitive systems, and several demonstrations of mass sensors that have detection limits as low 10⁻²¹ g, approximately the mass of a single protein molecule, have been performed. While these experiments have been performed in idealised environments, practical cantilever-based systems have been demonstrated for the detection of a wide range of single analytes.

According to the prior art, a portion of the micro-cantilever is generally coated with an analyte selective coating to which the analyte is adsorbed. There are then two common modes of operation of micro-cantilever sensors, namely static and dynamic.

In the static mode, a stress differential is induced across the cantilever due to preferential adsorption of an analyte onto the analyte selective coating causing the cantilever to bend. The extent of the bending is in direct relation to the amount of analyte adsorbed. The stress differential can be induced by the analyte causing swelling of an overlayer, or by changes in the Gibbs free energy of the surface.

In the dynamic mode, the adsorbed analyte changes the mass of the cantilever and hence its mechanical resonance frequency. The rate and size of the change in resonance frequency is then measured to estimate the analyte concentration. Active sensing using these structures is achieved by resonant excitation.

In general, long, compliant cantilevers are required for sensitive static sensors, while high sensitivity for dynamic sensors dictate that short, stiff cantilevers with high Q-factor mechanical resonances are needed. The most sensitive MEMS-based sensors to date have been based on measurements of resonance frequency.

The performance of dynamic mode cantilever sensors is degraded when damping is high. In particular such degradation occurs in a fluid or even a gas if squeezed film damping is significant.

Readout technologies used with micro-cantilever sensors are primarily based on optical techniques developed for atomic force microscopy (AFM) analysis. Here, light is reflected from the cantilever tip to a distant quadrant detector, which process is referred to as optical leveraging. Electrical sensing and optical sensing techniques are also used. Electrical sensing includes piezoresistive, piezoelectric, capacitive, Lorentz force/emf sensing and tunneling current techniques. Optical sensing techniques include optical sensing based on optical interference, the optical interference being either in an interferometer or in the use of diffraction from an optical grating formed by a line of cantilevers. This latter configuration using an optical grating formed by a line of cantilevers is often described as an array in literature, but is still effectively a sensor for a single analyte.

Another approach to analyte detection is where large, compact, integrated arrays of individual sensors are used, particularly for multi-analyte, multi-analysis applications. These are particularly useful when an unknown substance is to be identified or if there is a number of chemical species to be tested for simultaneously. Examples of such requirements can be found in the screening of food for pesticide residues where there are many different potential contaminants, detection of different antibodies in a single blood sample, or the presence of any of the many possible illicit drugs or explosives in luggage. Additionally, an array of sensors can also give significantly improved statistics of detection (including fewer false-positives and false-negatives) by averaging the response over a large number of sensors, and allows the use of multivariate statistical chemometric techniques, as are typically applied in spectroscopic analysis.

There are several disadvantages with current analyte detection techniques. Firstly, there is currently no known method to cost-effectively integrate a large number of sensors onto a single substrate. Additionally, there is a lack of a compact, robust and cost-effective read-out technology that combines high sensitivity with high dynamic range.

A limitation to the application of cantilever sensors to sensor arrays results from the technologies currently available to measure the changes in a cantilever induced by an analyte. A problem with AFM-based cantilever systems in sensor arrays is that they are very large, as they incorporate bulky free space optics. Furthermore, a problem with electrical cantilever systems is that they require extensive power on-chip electronics.

### SUMMARY OF THE INVENTION

In one form, the invention resides in an apparatus for analysing a sample, said apparatus comprising:

a waveguide, including an input for receiving light and an output;

a first microring resonator optically coupled to said waveguide; and

a first flexible optical waveguide optically coupled to said first microring resonator;

wherein said first flexible optical waveguide includes a portion for interacting with said sample; and

wherein light transmitted from said output of said waveguide is modulated at a first optical resonant wavelength of said first microring resonator and said modulation is a function of a distance between said first flexible optical waveguide and said first microring resonator.

Preferably, said first flexible optical waveguide comprises one of: an optical cantilevered waveguide; and an optical beam waveguide.

Preferably, said portion for interacting with the sample comprises an analyte selective coating selective to one or more analytes.

Alternatively or additionally, said portion for interacting with the sample comprises a tip. Preferably, said tip is for physically interacting with a surface of the sample. Alternatively, said tip includes a ferromagnetic material that reacts to magnetic areas of said sample.

Preferably, said apparatus further comprises a detection module, connected to said output of said waveguide, which detection module analyses said light on said output to determine one of: an amount of analyte in said sample, and a contour of said sample. The contour can be a physical contour or a magnetic contour, for example.

Preferably, said apparatus comprises a second microring resonator optically coupled to said waveguide, and a second flexible optical waveguide optically coupled to said second microring resonator wherein light transmitted from said output of said waveguide is additionally modulated at a second optical resonant wavelength of said second microring and said additional modulation is a function of a distance between said second flexible optical waveguide and said second microring resonator.

Preferably, said first microring resonator and said second microring resonator have different optical resonant wavelengths. Preferably, said different optical resonant wavelengths are a function of any one or more of a diameter of said microring resonator and a refractive index of a material the microring resonator is made from.

Preferably, said first microring resonator, said second microring resonator, said first flexible optical waveguide and said second flexible optical waveguide are fabricated on a silicon on insulator wafer.

Alternatively, said first microring resonator, said second microring resonator, said first flexible optical waveguide and said second flexible optical waveguide are fabricated on a silicon substrate with an insulating layer formed on top.

Preferably, said first microring resonator and said second microring resonator are fabricated on a first plane; said first flexible optical waveguide and said second flexible optical waveguide are fabricated on a second plane; and said first plane is adjacent said second plane.

Preferably, said detection module identifies a modulation of said first flexible optical waveguide at said first resonant optical wavelength and a modulation of said second flexible optical waveguide at said second resonant optical wavelength.

Optionally, a second flexible optical waveguide is optically coupled to said first microring resonator.

Optionally, said first flexible optical waveguide and said second flexible optical waveguide have different stiffnesses.

Optionally, said detection module analyses light modulated according to either or both said first flexible optical waveguide or said second flexible optical waveguide.

In another form, the invention resides in a method of analysing a sample, said method comprising:

inputting light into a waveguide, wherein said waveguide is optically coupled to a first microring resonator, said first microring resonator optically coupled to a first flexible optical waveguide;

applying said sample to said first flexible optical waveguide wherein said first flexible optical waveguide is configured to interact with said sample;

coupling light into said first microring resonator at a first optical resonant wavelength of said first microring resonator;

modulating said light at said first optical resonant wavelength according to a function of a distance between said first flexible optical waveguide and said first microring resonator; and

analysing said modulated light at an output of said waveguide.

Preferably, said first flexible optical waveguide comprises one of: an optical cantilevered waveguide; and an optical beam waveguide.

Preferably, said first flexible optical waveguide is configured to interact with the sample through an analyte selective coating selective to one or more analytes. Alternatively or additionally, said first flexible optical waveguide is configured to interact with the sample through a tip.

Preferably, said step of coupling light further comprises coupling light into a second microring resonator at a second optical resonant wavelength of said second microring resonator, wherein said second microring resonator is optically coupled to said waveguide and said second microring resonator is optically coupled to a second flexible optical waveguide; and said step of modulating said light further comprises modulating said light at said second optical resonant wavelength according to a function of a distance between said second flexible optical waveguide and said second microring resonator.

Preferably, said step of analysing said light involves using wavelength analysis.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 shows a side sectional view of an optical cantilevered waveguide, according to the prior art;

FIG. 2a shows a top view of an apparatus for detecting analytes according to a first embodiment of the present invention;

FIG. 2b shows a side cross section view of the apparatus of FIG. 2a for detecting analytes according to a first embodiment of the present invention;

FIG. 3 shows a schematic diagram of an apparatus for detecting analytes according to a second embodiment of the present invention;

FIG. 4 shows a schematic diagram of an apparatus for detecting analytes according to a third embodiment of the present invention; and

FIG. 5 shows a schematic diagram of an apparatus for detecting analytes according to a fourth embodiment of the present invention.

### DETAILED DESCRIPTION

While the present invention is open to various modifications and alternative constructions, the example embodiments shown in the drawings will be described herein in detail. It is to be understood, however, there is no intention to limit the invention to the particular example forms disclosed. On the contrary, it is intended that the invention cover all modifications, equivalences and alternative constructions falling within the spirit and scope of the invention as expressed in the appended claims.

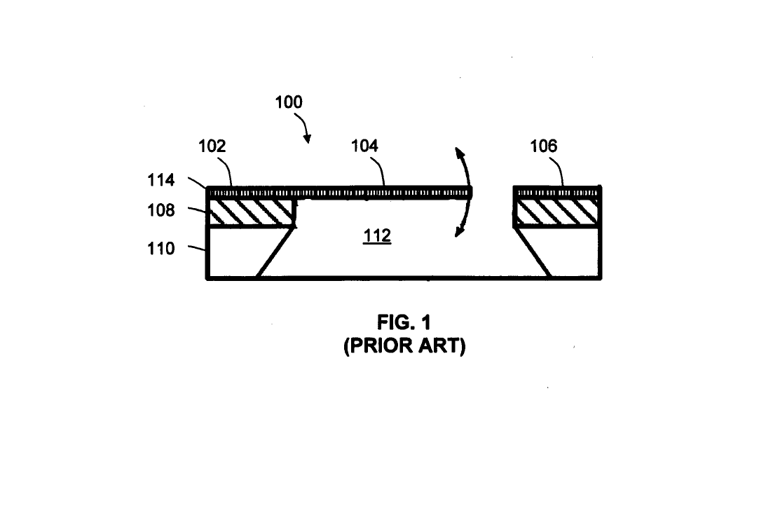

FIG. 1 shows a side sectional view of an optical cantilevered waveguide 100, according to the prior art. The optical cantilevered waveguide 100 comprises a fixed component 102 and a dynamic component 104. The fixed component is attached to an insulator 108 such as for example SiO₂ or Si3N₄. The insulator 108 is attached to a substrate 110 such as for example a Si substrate. This layered structure allows for the simple construction of the optical cantilevered waveguide 100 through layering of the substrate 110, the insulator 108 and the optical cantilevered waveguide 100. An area of the insulator 108 (and possibly also an area of the substrate 110) are then etched away, forming a void 112 under the dynamic component 104 of the optical cantilevered waveguide 100. The dynamic component 104 of the cantilevered waveguide 100 is optically coupled to a fixed waveguide 106.

The dynamic component 104 is free to move above the void 112 in the insulator 108. Upon adsorbtion of an analyte, the mass of the dynamic component 104 of the optical cantilevered waveguide 100 changes. This change in mass results in a change of a mechanical resonance frequency of the optical cantilevered waveguide 100.

Light enters at an end 114 of the fixed component 102 of the optical cantilevered waveguide 100 and propagates along the waveguide 100 to the dynamic component 104. Light exits the dynamic component 104 in a direction towards the fixed waveguide 106.

In a dynamic mode, the light entering the fixed waveguide 106 is amplitude modulated as a result of a coupling loss between the dynamic component 104 and the fixed waveguide 106 that is in close proximity to the dynamic component 104, which loss occurs as the dynamic component 104 vibrates. The light entering the fixed waveguide 106 is nominally modulated at twice the vibration frequency of the dynamic component 104 for symmetric vibration. Alternatively, in a static mode the dynamic component 104 of the optical cantilevered waveguide 100 may change shape upon adsorbtion of an analyte. In this case the light entering the fixed waveguide 106 has an amplitude based upon the shape of the dynamic component 104 of the optical cantilevered waveguide 100.

The light entering the fixed waveguide 106 is analysed to detect the presence of an analyte on the optical cantilevered waveguide 100. The light may be compared to light with known characteristics, such as for example light modulated due to the presence of an analyte. Alternatively, the mechanical resonance frequency or shape of the optical cantilevered waveguide 100 may be estimated and compared to pre-determined characteristics.

The present invention resides in an apparatus for analysing a sample. The apparatus comprises a waveguide, including an input and an output, for receiving light at the input, a microring resonator optically coupled to the waveguide, and a flexible optical waveguide optically coupled to the microring resonator. The flexible optical waveguide has a portion for interacting with the sample. The light on the output of the waveguide is modulated at an optical resonant wavelength of the microring resonator according to a function of a distance between the flexible optical waveguide and the microring resonator.

An advantage of the present invention is the ability to economically have a very large number of sensors on a small surface, enabling efficient detection of multiple analytes or efficient detection of a three dimensional surface, for example. Furthermore, sensors of the present invention are rugged and do not have bulky optics, and it is possible to have a separate signal processing unit.

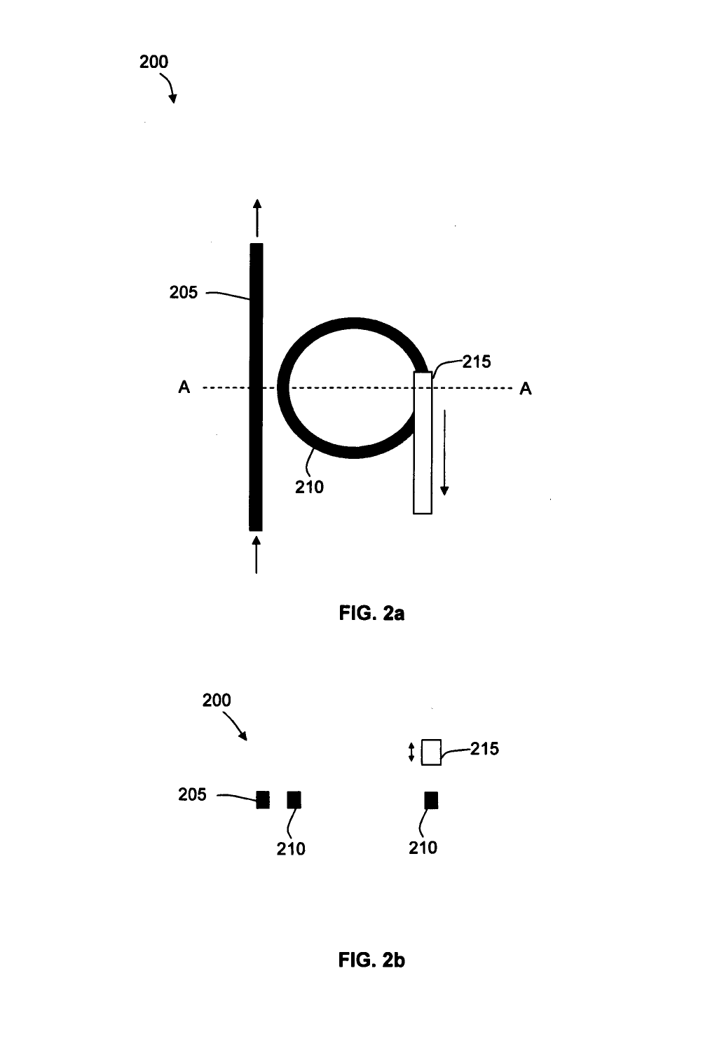

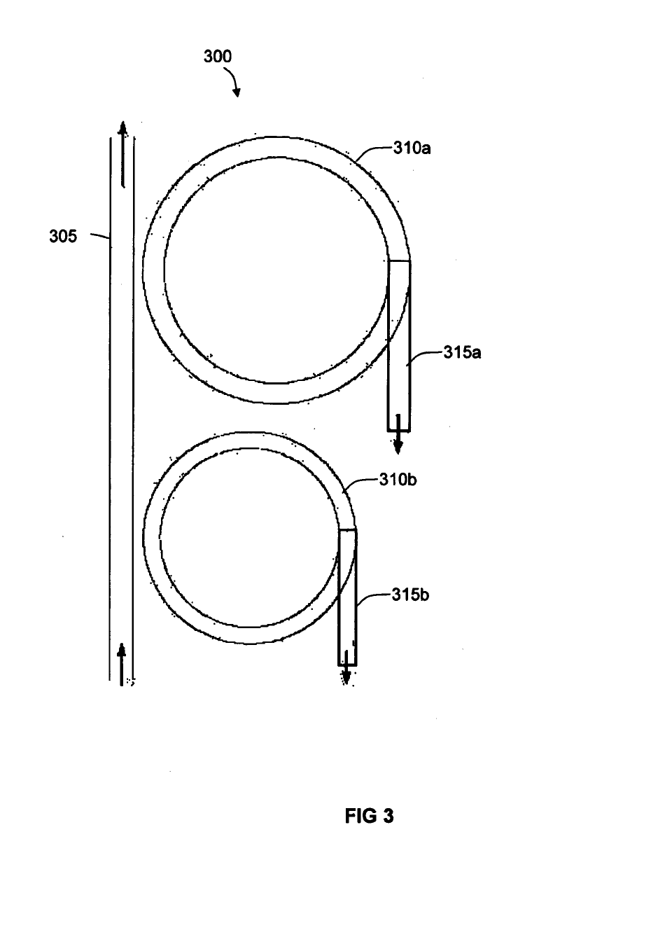

FIG. 2a shows a top view of an apparatus 200 and FIG. 2b shows a cross sectional view (A-A) of the apparatus 200 of FIG. 2a for analysing a sample according to a first embodiment of the present invention. The apparatus 200 includes a waveguide 205, a microring resonator 210, and an optical cantilevered waveguide 215.

The waveguide 205 is adjacent and optically coupled to the microring resonator 210. The optical cantilevered waveguide 215 is adjacent and optically coupled to the microring resonator 210 on an opposite side of the microring resonator 210 to the waveguide 205.

In one embodiment, the waveguide 205, the microring resonator 210 and the optical cantilevered waveguide 215 are fabricated on a silicon on insulator (Sol) wafer. The waveguide 205 and the microring resonator 210 are fabricated on a first plane of the silicon on insulator wafer and the optical cantilevered waveguide 215 is fabricated on a second plane of the silicon on insulator wafer. The second plane is adjacent and in spaced relation to the first plane, resulting in the optical cantilevered waveguide 215 being on top of and overlapping the microring resonator 210.

Alternatively, the microring resonator 210 may be fabricated in the same plane, and adjacent the optical cantilevered waveguide 215. In addition it should be appreciated that the waveguide 205 may be fabricated on a different plane to the microring resonator 210 such that the waveguide 205 is on top of and overlapping the microring resonator 210, and whereby light is coupled from the waveguide 205 to the microring resonator 210 without the waveguide 205 and the microring resonator 210 touching.

An alternative to fabricating the apparatus 200 on a Silicon on Insulator wafer may be to fabricate the apparatus 200 on a silicon substrate with an insulating layer formed on top of the silicon substrate. However it should be appreciated that any suitable structure may be used to fabricate the apparatus 200.

As previously explained with reference to FIG. 1, the optical cantilevered waveguide 215 comprises a fixed component and a dynamic component, wherein the dynamic component is free to move above a void.

Upon adsorbtion of an analyte, the mass of the optical cantilevered waveguide 215 changes. In a dynamic mode of operation, the change in mass results in a change of a mechanical resonance frequency of the optical cantilevered waveguide 215. In a static mode of operation, the presence of an analyte causes a change in shape of the optical cantilevered waveguide 215.

According to an alternative embodiment (not shown), the optical cantilevered waveguide interacts with the sample through a tip (not shown), for example for atomic force measurements. The tip can physically interact with a surface of the sample, or react according to magnetic areas of said sample, for example.

The optical cantilevered waveguide 215 is positioned such that movement of the dynamic component is substantially perpendicular to the microring resonator 210. Movement of the dynamic component of the optical cantilevered waveguide 215 results in a change in distance between the optical cantilevered waveguide 215 and the microring resonator 210, and hence a change in the amount of light coupled from the waveguide 205 through the microring resonator 210 to the optical cantilevered waveguide 215. This change in light, or modulation, may be measured at the output of the waveguide 205 to determine the presence and/or concentration of an analyte.

Light input to the waveguide 205 is coupled to the microring resonator 210 at an optical resonant wavelength of the microring resonator 210. The optical resonant wavelength is dependent on a function of the diameter or circumference of the microring resonator 210 and the refractive index of the material that the microring resonator 210 is made from, and is given by the following equation:

$$λ = \frac{L}{m} {n}_{eff} \qquad Eq . 1$$

where:

λ is the optical resonant wavelength;

L is the round trip or the circumference of the microring resonator 210 and is given by π×d, where d is the diameter of the microring resonator 210;

m is a cavity mode order (1, 2, 3 . . . ); and

n_{eff} is the refractive index of the material that the microring resonator is made from.

Light output from the waveguide 205 is then modulated at the optical resonant wavelength of the microring resonator 210, where such modulation is effected according to a function of the change in distance between the optical cantilevered waveguide 215 and the microring resonator 210. A corresponding modulation occurs at an output of the optical cantilevered waveguide 215. The modulated light at the output of the waveguide 205 then may be analysed and estimated to determine the presence and/or a concentration of analytes. Alternatively, the modulated light may be analysed at an output of the optical cantilevered waveguide 215. Finally, the modulated light may be compared to known modulations for particular analytes and concentrations of analytes.

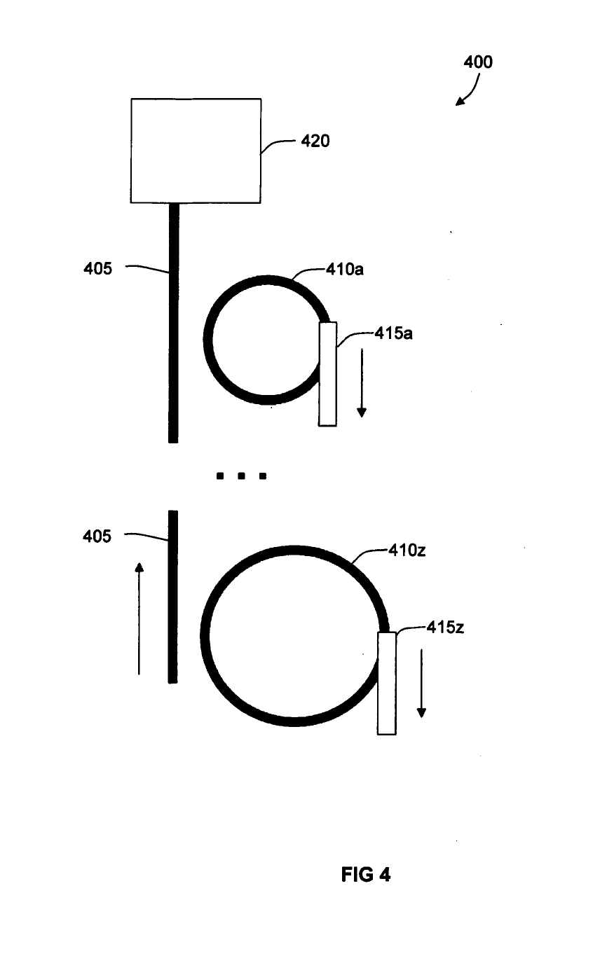

FIG. 3 shows a schematic diagram of an apparatus 300 for analysing a sample according to a second embodiment of the present invention. The apparatus is similar to the apparatus 200 of FIG. 2, except that the apparatus 300 includes a waveguide 305 optically coupled to two microring resonators 310a, 310b, where each microring resonator 310a, 310b is optically coupled to a respective optical cantilevered waveguide 315a, 315b.

A first optical cantilevered waveguide 315a is positioned such that movement of a dynamic component of the first optical cantilevered waveguide 315a is substantially perpendicular to a first microring resonator 310a. A second optical cantilevered waveguide 315b is positioned such that movement of a dynamic component of the second optical cantilevered waveguide 315b is substantially perpendicular to a second microring resonator 310b.

Similar to the first embodiment, the first microring resonator 310a and the second microring resonator 310b may be fabricated on a first plane of a silicon on insulator wafer, and the first optical cantilevered waveguide 315a and the second optical cantilevered waveguide 315b may be fabricated on a second plane of a silicon on insulator wafer. Alternatively the apparatus 300 may be fabricated on a silicon substrate with an insulating layer on top.

Light input to the waveguide 305 is coupled to the first microring resonator 310a at a first optical resonant wavelength of the first microring resonator 310a. Similarly, light input to the waveguide 305 is coupled to the second microring resonator 310b at a second optical resonant wavelength of the second microring resonator 310b. Light at an output of the waveguide 305 is modulated at the first optical resonant wavelength according to a function of a distance between the first optical cantilevered waveguide 315a and the first microring resonator 310a. A corresponding amount of light is modulated at an output of the first optical cantilevered waveguide 315a.

Similarly, the light at the output of the waveguide 305 at the second optical resonant wavelength is additionally modulated according to a function of a distance between the second optical cantilevered waveguide 315b and the second microring resonator 310b. A corresponding amount of light is modulated at an output of the second optical cantilevered waveguide 315b.

The modulated light output from the waveguide 305 at the first and second optical resonant wavelengths may be analysed for the presence and/or concentration of analytes, or a contour of a sample, either in real time or at a later time. Alternatively, the modulated light may be analysed at an output of the each optical cantilevered waveguide 315. Furthermore, light output from each optical cantilevered waveguide 315 may be multiplexed and subsequently analysed.

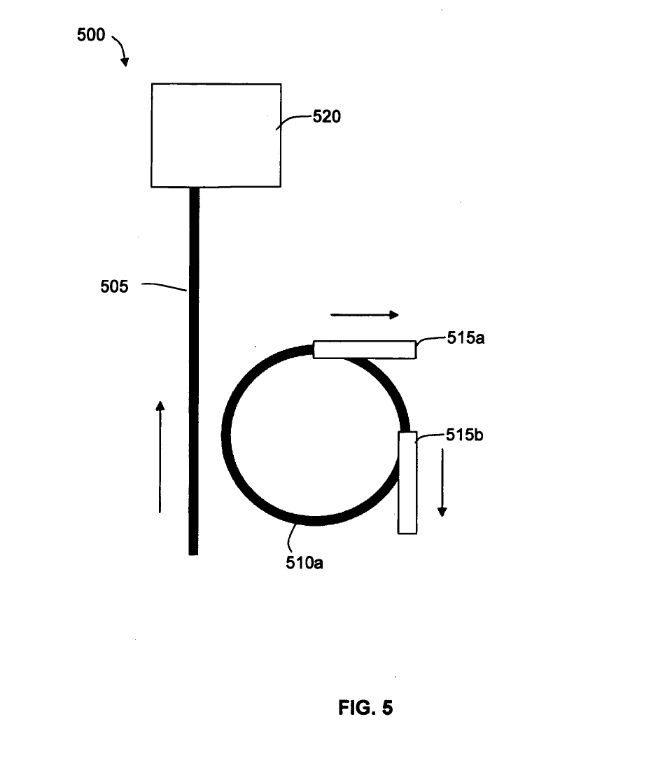

FIG. 4 shows a schematic diagram of an apparatus 400 for analysing a sample according to a third embodiment of the present invention. Similar to the embodiment shown in FIG. 3, the apparatus 400 includes a waveguide 405, a plurality of microring resonators 410a-410z and a plurality of optical cantilevered waveguides 415a-415z. In addition the apparatus 400 includes a detection module for analysing light output from the waveguide 405.

The waveguide 405 is optically coupled to the plurality of microring resonators 410a-410z. Furthermore, each of the plurality of optical cantilevered waveguides 415a to 415z is optically coupled to a respective microring resonator 410a to 410z.

Similar to the previous embodiments, light, at an optical resonant wavelength of each of the microring resonators 410a-410z at an output of the waveguide 405, is modulated according to function of a distance between a respective optical cantilevered waveguide 415a to 415z and an associated microring resonator 410a-410z. Similarly, a corresponding amount light is modulated at an output at each of the optical cantilevered waveguides 415a to 415z.

The detection module 420 is connected to the output of the waveguide 405 and analyses the modulated light transmitted from the output of the waveguide 405, for detection of the presence of the one or more analytes in the sample or analysis of a contour of a sample, for example. Alternatively a detection module 420 may be optically coupled to an output of each of the optical cantilevered waveguides 415a to 415z.

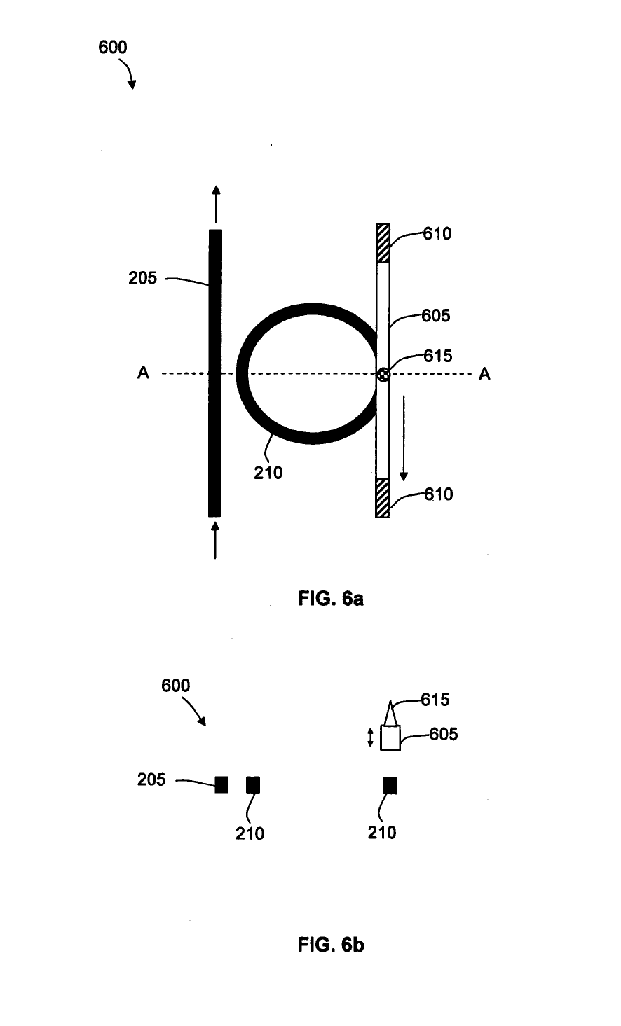

FIG. 5 shows a schematic diagram of an apparatus 500 for analysing a sample according to a fourth embodiment of the present invention. The apparatus 500 includes a waveguide 505, a microring resonator 510, a first optical cantilevered waveguide 515a, a second optical cantilevered waveguide 515b, and a detection module 520.

The apparatus 500 is similar to the apparatus shown in FIG. 2, except that a single microring resonator 510 is optically coupled to two optical cantilevered waveguides 515a, 515b. Although only two optical cantilevered waveguides 515a, 515b are shown it should be appreciated that the apparatus 500 may include more than two optical cantilevered waveguides 515 coupled to the microring resonator 510.

In this embodiment, the optical cantilevered waveguides 515a, 515b have different stiffnesses and hence have different mechanical resonant frequencies. The stiffnesses of the optical cantilevered waveguides 515a, 515b affects the frequency of resonance in the case of the dynamic mode of operation, or affects the amount the optical cantilevered waveguides 515a, 515b bend in the case of the static mode of operation.

The detection module 520 may, in the case of the dynamic mode, detect the different resonance frequency according to each optical cantilevered waveguide 515a, 515b. From the resonant frequencies and/or a corresponding amplitude, the detection module 520 is able determine a type and concentration of an analyte.

Alternatively, the detection module 520 is able to select which optical cantilevered waveguide 515a, 515b is operational. Once one of the optical cantilevered waveguides 515a, 515b has been enabled, the modulated light output from the waveguide 505 due to the enabled optical cantilevered waveguide 515a, 515b may be analysed by the detection module 520 for the presence of analytes or to determine a contour of the sample.

FIG. 6a shows a top view of an apparatus 600 for analysing a sample according to a fifth embodiment of the present invention, and FIG. 6b shows a cross sectional view (A-A) of the apparatus 600 of FIG. 6a.

The apparatus 600 includes a waveguide 205 and a microring resonator 210, similar to the apparatus 200 of FIG. 2, but instead of an optical cantilevered waveguide 215, the apparatus 600 includes a beam 605 which is flexible.

The beam 605 is anchored at both ends via attachment means 610 and is otherwise free to move around a void. The beam 605 includes a tip 615, which can interact directly with a sample. Upon interaction with a sample, the tip 615 will apply pressure to the beam 605 thus causing the beam 605 to flex and move towards or away from the microring resonator 210.

The beam 605 is adjacent and optically coupled to the microring resonator 210 on an opposite side of the microring resonator 210 to the waveguide 205.

The beam 605 is positioned such that movement caused by the tip 615 is substantially perpendicular to the microring resonator 210. Such movement results in a change in distance between the beam 605 and the microring resonator 210, and hence a change in the amount of light coupled from the waveguide 205 through the microring resonator 210 to the beam 605. This change in light, or modulation, may be measured at the output of the waveguide 205 to determine a surface of the sample.

By anchoring the beam 605 at both ends, an increased stiffness and/or torsional stiffness can be achieved compared to the optical cantilevered waveguide 215 of FIG. 2.

As will be readily understood by one skilled in the art, the abovementioned figures are illustrative of the nature of the connections of multiple flexible optical waveguides 205a, 205b, 305a to 305z, 605 and microring resonators 210a, 210b, 310a to 310z. Many such flexible optical waveguides 205a, 205b, 305a to 305z, 605 and microring resonators 210a, 210b, 310a to 310z may be optically coupled in various arrangements. When first and second optical cantilevered waveguides or microring resonators are exemplified, there is no intention to restrict the invention and it is understood by a person skilled in the art that these first and second elements may represent a first and second element from a plurality of elements.

Additionally, the detection module 420, 520 need not be directly connected to the apparatus 400, 500. The modulated light can, for example, be recorded and analysed at a different time than the application of the sample.

As will be readily understood by a person skilled in the art, analysis of the sample need not be restricted to a particular sample type or particular type of analysis. For example, a sample can comprise a media containing encoded data, for example a magnetic media or media wherein data is encoded on a surface of said media. Similarly, analysis can comprise reading or decoding data from a media, or other analysis of a sample.

Furthermore, the direction of travel of the light through different components of the system is for illustrative purposes. As is understood by a person skilled in the art, light can travel in either direction through a component.

Similarly, the terms such as light, optical source and optical signal are used and, as is understood by a person skilled in the art, a light or optical signal may be converted back and forth to a signal of another type, for example an electronic signal. When light, an optical source, and an optical signal are used, the light signal may actually be sent and/or processed in a non-optical form such as an electrical signal. An example of this is the detection module 420, 520 which may receive an electronic version of the optical signal.

In an alternative embodiment of the invention, not all optical microring resonators 210, 310a, 310b, 410a-410z, 510 in an apparatus have different diameters. It may also be desirable to have multiple optical cantilevered waveguides 215, 3151, 315b, 415a-415z, 515a, 515b, for example, configured to redundantly detect the presence of the same analyte to improve the reliability of results, or for other purposes.

As will be understood by those having ordinary skill in the art, in light of the present description, an advantage of the present invention is the ability to economically have a very large amount of sensors on a small surface, enabling efficient detection of multiple analytes or accurate measurement of a contour of a sample, for example. Furthermore, sensors of the present invention are rugged, do not have bulky optics, and it is possible to have a separate signal processing unit.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

Limitations in any patent claims should be interpreted broadly based on the language used in the claims, and such limitations should not be limited to specific examples described herein. In this specification, the terminology “present invention” is used as a reference to one or more aspects within the present disclosure. The terminology “present invention” should not be improperly interpreted as an identification of critical elements, should not be improperly interpreted as applying to all aspects and embodiments, and should not be improperly interpreted as limiting the scope of any patent claims.

1. An apparatus for analysing a sample, said apparatus comprising:
a waveguide, including an input for receiving light and an output;
a first microring resonator optically coupled to said waveguide; and a first flexible optical waveguide optically coupled to said first microring resonator;
wherein said first flexible optical waveguide includes a portion for interacting with said sample; and
wherein light transmitted from said output of said waveguide is modulated at a first optical resonant wavelength of said first microring resonator and said modulation is a function of a distance between said first flexible optical waveguide and said first microring resonator.

2. An apparatus according to claim 1, wherein said first flexible optical waveguide comprises one of: an optical cantilevered waveguide; and an optical beam waveguide.

3. An apparatus according to claim 1, wherein said portion for interacting with the sample comprises an analyte selective coating selective to one or more analytes.

4. An apparatus according to claim 1, wherein said portion for interacting with the sample comprises a tip for physically interacting with a surface of the sample, or reacting to magnetic areas of said sample.

5. An apparatus according to claim 1, further comprising a detection module, connected to said output of said waveguide, which detection module analyses said light on said output to determine one of: an amount of analyte in said sample, and a contour of said sample.

6. An apparatus according to claim 1, further comprising a second microring resonator optically coupled to said waveguide, and a second flexible optical waveguide optically coupled to said second microring resonator wherein light transmitted from said output of said waveguide is additionally modulated at a second optical resonant wavelength of said second microring and said additional modulation is a function of a distance between said second flexible optical waveguide and said second microring resonator.

7. An apparatus according to claim 6, wherein said first microring resonator and said second microring resonator have different optical resonant wavelengths.

8. An apparatus according to claim 7, wherein said different optical resonant wavelengths are a function of any one or more of a diameter of said microring resonator and a refractive index of a material the microring resonator is made from.

9. An apparatus according to claim 6, wherein said first microring resonator, said second microring resonator, said first flexible optical waveguide and said second flexible optical waveguide are fabricated on a silicon on insulator wafer.

10. An apparatus according to claim 6, wherein said first microring resonator, said second microring resonator, said first flexible optical waveguide and said second flexible optical waveguide are fabricated on a silicon substrate with an insulating layer formed thereon.

11. An apparatus according to claim 6, wherein said first microring resonator and said second microring resonator are fabricated on a first plane; said first flexible optical waveguide and said second flexible optical waveguide are fabricated on a second plane; and said first plane is adjacent said second plane.

12. An apparatus according to claim 6, further comprising a detection module, connected to said output of said waveguide, which detection module analyses said light on said output to determine one of: an amount of analyte in said sample, and a contour of said sample, wherein said detection module identifies a modulation of said first flexible optical waveguide at said first resonant optical wavelength and a modulation of said second flexible optical waveguide at said second resonant optical wavelength.

13. An apparatus according to claim 1, further comprising a second flexible optical waveguide, said second flexible optical waveguide optically coupled to said first microring resonator.

14. An apparatus according to claim 13, wherein said first flexible optical waveguide and said second flexible optical waveguide have different stiffnesses.

15. An apparatus according to claim 13 further comprising a detection module, connected to said output of said waveguide, which detection module analyses said light on said output to determine one of: an amount of analyte in said sample, and a contour of said sample, wherein said detection module analyses light modulated according to either or both said first flexible optical waveguide or said second flexible optical waveguide.

16. A method of analysing a sample, said method comprising:
inputting light into a waveguide, wherein said waveguide is optically coupled to a first microring resonator, said first microring resonator optically coupled to a first flexible optical waveguide;
applying said sample to said first flexible optical waveguide wherein said first flexible optical waveguide is configured to interact with said sample;
coupling light into said first microring resonator at a first optical resonant wavelength of said first microring resonator;
modulating said light at said first optical resonant wavelength according to a function of a distance between said first flexible optical waveguide and said first microring resonator; and
analysing said modulated light at an output of said waveguide.

17. A method according to claim 16, wherein said first flexible optical waveguide comprises one of: an optical cantilevered waveguide; and an optical beam waveguide.

18. A method according to claim 16, wherein said first flexible optical waveguide is configured to interact with the sample through an analyte selective coating selective to one or more analytes.

19. A method according to claim 16, wherein said first flexible optical waveguide is configured to interact with the sample through a tip for physically interacting with a surface of said sample, or reacting to magnetic areas of said sample.

20. A method according to claim 16, wherein said step of coupling light further comprises coupling light into a second microring resonator at a second optical resonant wavelength of said second microring resonator, wherein said second microring resonator is optically coupled to said waveguide and said second microring resonator is optically coupled to a second flexible optical waveguide; and said step of modulating said light further comprises modulating said light at said second optical resonant wavelength according to a function of a distance between said second flexible optical waveguide and said second microring resonator.
